(19) United States
(12) Patent Application Publication
(10) Pub. No.: US 2004/0233220 A1
(43) Pub. Date: Nov. 25, 2004

(54) Display device

(76) Inventors: Jean-Francois Decaux, London (GB); Jean-Charles Decaux, Madrid (ES); Jean-Sebastien Decaux, Neuilly-Sur-Seine (FR)

Correspondence Address: GOTTLIEB RACKMAN & REISMAN PC, 270 MADISON AVENUE, 8TH FLOOR, NEW YORK, NY, 100160601

(21) Appl. No.: 10/664,343

(22) Filed: Sep. 17, 2003

(30) Foreign Application Priority Data
May 21, 2003 (FR) 03 06093

(51) Int. Cl. G09G 5/00

(52) U.S. Cl. 345/619

(57) ABSTRACT

A display device containing a poster which is provided with an optically transparent window, and an image-presenting device which presents an internal display that can be seen through the window in the poster. A geometrical parameter selected from the position of the internal display relative to the poster, the shape of the internal display, and the size of the internal display is adjusted so that the internal display is in register with the window in the poster being presented.

The present invention relates to display devices.

More particularly, the invention relates to a display device containing: at least one poster which is provided with an optically transparent window (either constituted by an opening or by a transparent solid material); and at least one image-presenting device which presents an “internal” display that can be seen through said window in the poster.

### BACKGROUND OF THE INVENTION

Document FR-A-2 793 061 describes an example of such a display device which operates quite satisfactorily.

### OBJECTS AND SUMMARY OF THE INVENTION

An object of the present invention is to make further improvements to display devices of that type, in particular in order to increase the possibilities for use, and the ease of use.

To this end, in the invention, a display device of the type in question:

includes adjustment means adapted for physically modifying at least one geometrical parameter selected from: the position of the internal display relative to the poster, the shape of the internal display, and the size of the internal display;

and said geometrical parameter used is such that the internal display is in register with the window in the poster being presented.

By means of these provisions, the window in the poster can differ from one poster to another, which gives more freedom to the creator of the poster, and makes it easier to adapt to existing posters for providing said windows in them.

In preferred embodiments of the display device of the invention, it is optionally possible to use any of the following provisions:

the adjustment means comprise an electronic central processing unit belonging to the display device, said central processing unit having in its memory at least one item of adjustment data corresponding to said geometrical parameter and said central processing unit being adapted for physically modifying said geometrical parameter of the internal display;

the image-presenting device is an electronic screen, and the central processing unit is adapted for determining in the screen an active portion within which the internal display is presented;

the electronic central processing unit is adapted for controlling drive means for mechanically moving the image-presenting device relative to the poster;

the display device has at least one interface adapted for loading at least said item of adjustment data into the central processing unit;

said interface comprises at least one data medium reader (for reading CD-ROMs, DVDs, disks, or the like);

said interface comprises a telecommunications interface;

the display device includes at least one sensor adapted for reading data from the poster (e.g. by optically reading data in the form of a bar code or the like) and for transferring said data to the central processing unit;

the central processing unit is adapted for downloading at least said item of adjustment data as a function of the data read from the poster;

the image-presenting device is an electronic screen, and, as a function of the data read from the poster, the central processing unit is adapted for downloading, via a communications interface belonging to the display device, at least one internal display program to be displayed on the screen; and

the image-presenting device is an electronic screen, and, as a function of the data read from the poster, the central processing unit is adapted for presenting on the screen an internal display program that corresponds to the poster, and that is selected from a plurality of internal display programs stored in the display device.

The invention also provides a display method for presenting simultaneously in the same display device at least one poster which is provided with an optically transparent window, and at least one internal display that is presented on an image-presenting device and that can be seen through said window in the poster, in which display method at least one geometrical parameter is physically modified so that the internal display is in register with the window in the poster that is being presented, said geometrical parameter being selected from: the position of the internal display relative to the poster, the shape of the internal display, and the size of the internal display.

In preferred implementations of the method of the invention, it is optionally possible to use any of the following provisions:

the internal display is presented on an electronic screen, and, for modifying said geometrical parameter, an active portion is determined in the screen, and the internal display is caused to be displayed in said active portion;

in order to modify said geometrical parameter, the image-presenting device is moved mechanically relative to the poster;

while a poster is being changed, at least one item of adjustment data corresponding to said geometrical parameter is loaded into an electronic central processing unit belonging to the display device via an interface, and said central processing unit physically modifies said geometrical parameter of the internal display as a function of said item of adjustment data;

the interface comprises a reader interface for reading data media, and said item of adjustment data is loaded by causing a data medium to be read by said interface;

the interface comprises a telecommunications interface, and said item of adjustment data is downloaded via said telecommunications interface;

data is read from the poster, and the item of adjustment data corresponding to the data read from the poster is downloaded;

the image-presenting device is an electronic screen, and at least one internal display program is downloaded that is to be displayed on the screen as a function of the data read from the poster; and

the image-presenting device is an electronic screen, data is read from the poster, and, as a function of said data, an internal display program that corresponds to the poster and that is selected from a plurality of internal display programs is presented on the screen.

### BRIEF DESCRIPTION OF THE DRAWINGS

Other characteristics and advantages of the invention appear on reading the following description of one of its embodiments given by way of non-limiting example with reference to the accompanying drawings.

In the drawings:

FIG. 1 is a perspective view of an embodiment of a display device of the invention;

FIG. 2 is a diagrammatic vertical section view of the display device of FIG. 1;

FIG. 3 is a detail view showing how the screen of the device of FIG. 2 can be mounted; and

FIG. 4 is a block diagram of the control circuit corresponding to the display device of FIGS. 1 and 2.

### MORE DETAILED DESCRIPTION

In the various figures, like references designate elements that are identical or similar.

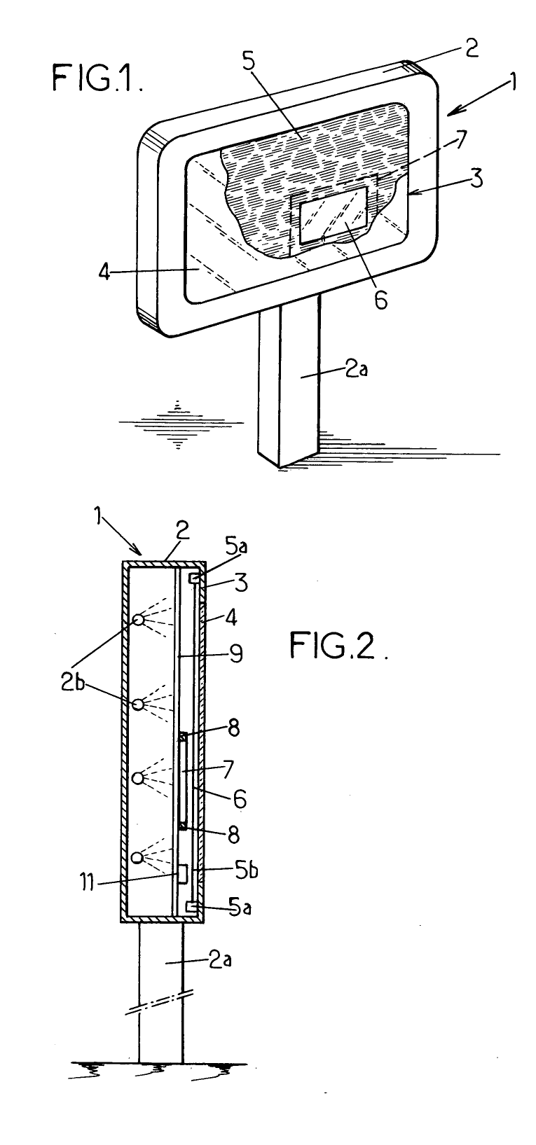

FIGS. 1 and 2 show a display device 1 which is, for example, in the form of a billboard-forming display panel designed to be disposed in a public place, e.g. on a public thoroughfare, in an airport, in a station, or in a shopping mall, etc.

The display device 1 has a closed rigid outer case 2 which may, for example, stand on the ground by means of a stand 2a, or which may optionally be fixed to a wall or the like. The outer case 2 has a front face provided with a transparent opening 3 which is generally closed by glazing 4.

At least one poster 5, which may be for advertising purposes or for general information purposes, is disposed inside the case 2, behind the glazing 4. The poster may be fixed to the inside of the case 2 by being tensioned over a frame 5a or the like. The poster 5 may be made of paper, or in the form of a translucent synthetic sheet, which is advantageously backlit by means of striplights 2b or the like.

Over most of its area, the poster 5 is sufficiently opaque to prevent an onlooker situated outside the case 2 from seeing inside the case through the poster. However, a portion of the area of the poster 5 is constituted by a window 6 that is optically transparent, and that makes it possible to see an internal image-presenting device 7 through the poster 5.

For example, the window 6 may be constituted by a sheet of flexible transparent synthetic material, but optionally, said window could be constituted merely by an opening provided through the poster 5. The window 6 has a rectangular shape in the example shown in the drawings, but said window may have any other desired geometrical shape and/or any other size and/or any other position within the poster 5.

The electronic screen 7 may, for example, be an image-presenting device of the plasma, liquid crystal, light-emitting diode (LED), or cathode ray tube type, or of some other type.

The screen 7 may be larger in size than the window 6 in the poster 5, in which case, said image-presenting device is controlled so as to have an internal display 7a over an active portion only of its area that is referred to below as the “active window”. Said active window is disposed, dimensioned, and shaped so as to be in register with the window 6 in the poster 5.

Thus, the internal display on the screen 7 may be adapted to match the dimensions and/or the location, and/or the shape of the window 6 in the poster 5, within the limits of the total area of the screen 7.

In addition, in order to adapt to different possible locations for the window 6 over the entire area of the poster 5, the screen 7 can optionally be mounted to move inside the case 2.

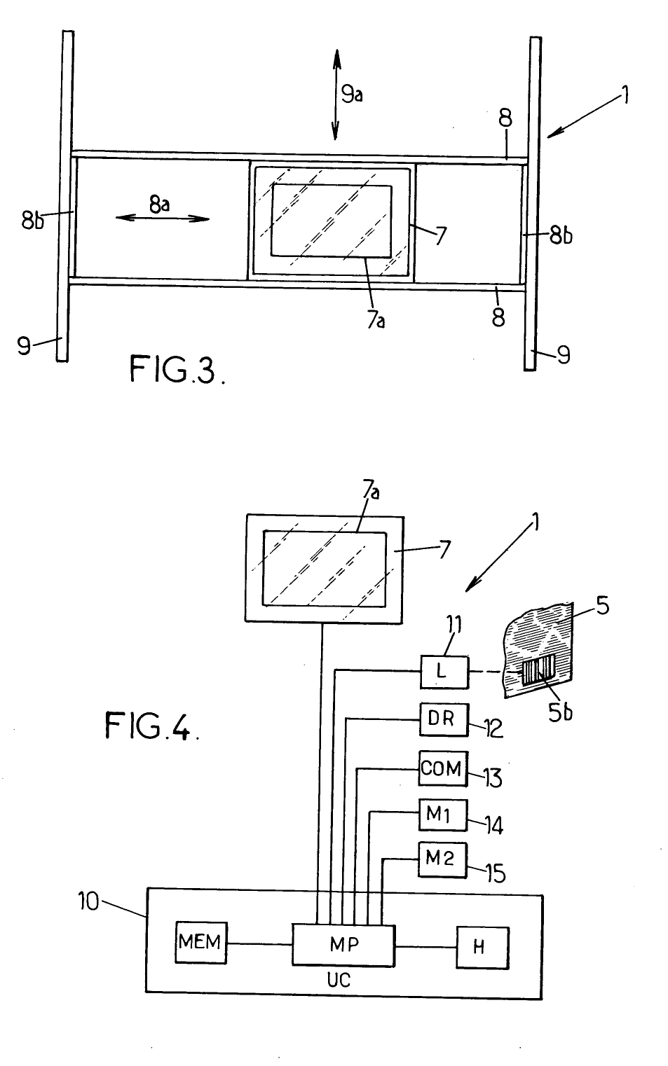

Thus, as shown in FIGS. 2 and 3, the screen may optionally be mounted to move horizontally and vertically, parallel to the glazing 4. For this purpose, the screen 7 may optionally be mounted to slide horizontally in the direction 8a on two horizontal runners 8, and said horizontal runners may be mounted to slide in the vertical direction 9a on two vertical runners 9 fixed to the inside of the case 2. Optionally, the two horizontal runners 8 may be interconnected at their ends via spacers 8b which can themselves be mounted to slide in the vertical runners 9.

Adjusting the position of the screen 7 by means of the runners 8, 9 may optionally be performed manually, but said adjustment is preferably automated and controlled, for example, by motors M1, M2 (see FIG. 4) which drive the screen 7 respectively horizontally and vertically, by means of any known drive device such as actuators, cables, or the like.

As shown in FIG. 4, the display device 1 may advantageously be controlled by an electronic central processing unit (CPU) 10, which may comprise, in particular, a microprocessor MP, a memory MEM, and a clock H. The microprocessor MP controls operation of the screen 7, and in particular the way in which said image-presenting device 7 broadcasts an internal display program (video, series of photographs, animated images, etc.), only within the active window 7a whose size and/or position and/or shape within the screen 7 are controlled by the microprocessor MP as a function of parameters stored in the memory MEM.

When the position of the screen 7 in the case 2 is adjustable, and when said adjustment is motor-driven, the microprocessor MP may optionally be connected to all or some of the following elements:

a reader 11 (L) adapted to read a code 5b carried by the poster 5 and identifying said poster, e.g. a bar code that can be read optically or a code of some other type;

a reader 12 for reading data media (DR), such as a drive for reading CD-ROMs, DVDs, disks, magnetic tape or some other medium;

a telecommunications interface 13 (COM) such as a modem associated with a wired telephone line or with a wireless telecommunications device; and

when the position of the screen 7 is adjustable and the adjustment is motor-driven, motors 14, 15 (M1, M2) adapted to adjust the position of the screen 7.

The above-described device operates as follows.

When an operator changes the poster 5, the bar code 5b or some other coding of the poster can be read by the reader 11, so that the microprocessor MP of the CPU can determine which poster it is, which internal display programs (videos, series of photos, animated images, or other types of program) correspond to said poster, and the size and/or the positioning and/or the shape of the window 6 of the poster. All of this data can be stored, for example, in the memory MEM of the CPU 10, e.g. by one of the following processes:

downloading from a remote central computer station (not shown) via the communication interface 13, either on the initiative of the CPU 10 or on the initiative of the remote central station; and

loading via the data medium reader 12, from a data medium inserted into the reader 12 by the operator who is changing the poster.

On the basis of this data, the microprocessor MP positions the screen 7 behind the window 6 by means of the motors 14, 15, if it is a motor-driven moving image-presenting device, and said microprocessor also determines the size and/or the shape and/or the location of the internal display 7a presented in the active window of the screen 7, so that said active window coincides as exactly as possible with the window 6.

The microprocessor MP then causes the internal display program that is to be presented to the public to be displayed in said active window 7a only, and also optionally causes the sound corresponding to the internal display to be broadcast over loudspeakers (not shown) associated with the display device 1.

In a variant of the invention, the position of the screen 7 may be adjusted manually by the operator while said operator is changing posters, or the adjustment possibility may optionally be omitted.

In another variant, it is possible for the user to use continuously the same active window on the screen 7 (optionally representing the entire screen 7), in which case only the position of the internal display relative to the poster 5 would be adjustable, as a function of the position of the window 6 in said poster.

In yet another variant, it is possible to omit either the data medium reader 12, or the communication interface 13.

In addition, as already known from the prior art, instead of having a fixed single poster 5, the display device 1 may contain a plurality of posters disposed in the form of a strip rolled up on motor-driven rollers (not shown) so as to be presented sequentially behind the glazing 4. In which case, each of the posters may carry a bar code 5b that is different from the others so that the microprocessor MP can determine at each instant which internal displays to present and the size and/or position and/or shape of the internal display 7a to present in the active window of the screen 7 to match the poster 5 being presented.

It should be noted that, when the poster 5 is fixed, the reader 11 and the bar code 5b may be omitted, in which case the internal display program to be presented on the screen 7 and the geometrical parameters relating to said internal display 7a (position and/or dimensions and/or shape of the active window relative to the poster 5) are loaded into the memory MEM of the CPU 10 while the poster is being changed, either by downloading or by a data medium being read via a reader 12, and the internal display(s) are presented automatically by the screen 7, without checking, by means of the bar code 5b, whether the poster 5 and the internal display match.

It should also be noted that the screen 7 may optionally be replaced by some other image-presenting device, e.g. a device for presenting posters that scroll past, the overall position of the device being adjustable inside the display device 1, e.g. by means of the position adjustment means M1, M2 described above.

What is claimed is:

1/ A display device containing:
at least one a poster which is provided with an optically transparent window; and
at least one image-presenting device which presents an “internal” display that can be seen through said window in the poster;
wherein said display device includes adjustment means adapted for physically modifying at least one geometrical parameter selected from: the position of the internal display relative to the poster, the shape of the internal display, and the size of the internal display;
and wherein said geometrical parameter used is such that the internal display is in register with the window in the poster being presented.

2/ A display device according to claim 1, in which the adjustment means comprise an electronic central processing unit belonging to the display device, said central processing unit having in its memory at least one item of adjustment data corresponding to said geometrical parameter and said central processing unit being adapted for physically modifying said geometrical parameter of the internal display.

3/ A display device according to claim 2, in which the image-presenting device is an electronic screen, and the central processing unit is adapted for determining in the screen an active portion within which the internal display is presented.

4/ A display device according to claim 2, in which the electronic central processing unit is adapted for controlling drive means for mechanically moving the image-presenting device relative to the poster.

5/ A display device according to claim 2, having at least one interface adapted for loading at least said item of adjustment data into the central processing unit.

6/ A display device according to claim 5, in which said interface comprises at least one data medium reader.

7/ A display device according to claim 5, in which said interface comprises a telecommunications interface.

8/ A display device according to claim 2, in which the display device includes at least one sensor adapted for reading data from the poster and for transferring said data to the central processing unit.

9/ A display device according to claim 7, in which the display device includes at least one sensor adapted for reading data from the poster and for transferring said data to the central processing unit, and in which the central processing unit is adapted for downloading at least said item of adjustment data as a function of the data read from the poster.

10/ A display device according to claim 8, in which the image-presenting device is an electronic screen, and, as a function of the data read from the poster, the central processing unit is adapted for downloading, via a communications interface belonging to the display device, at least one internal display program to be displayed on the screen.

11/ A display device according to claim 8, in which, the image-presenting device is an electronic screen, and, as a function of the data read from the poster, the central processing unit is adapted for presenting on the screen an internal display program that corresponds to the poster, and that is selected from a plurality of internal display programs stored in the display device.

12/ A display method for presenting simultaneously in the same display device at least one poster which is provided with an optically transparent window, and at least one internal display that is presented on an image-presenting device and that can be seen through said window in the poster, wherein at least one geometrical parameter is physically modified so that the internal display is in register with the window in the poster that is being presented, said geometrical parameter being selected from: the position of the internal display relative to the poster, the shape of the internal display, and the size of the internal display.

13/ A method according to claim 12, in which the image-presenting device is an electronic screen, and, for modifying said geometrical parameter, an active portion is determined in the screen, and the internal display is caused to be displayed in said active portion.

14/ A method according to claim 13, in which, in order to modify said geometrical parameter, the image-presenting device is moved mechanically relative to the poster.

15/ A method according to claim 12, in which, while a poster is being changed, at least one item of adjustment data corresponding to said geometrical parameter is loaded into an electronic central processing unit belonging to the display device via an interface, and said central processing unit physically modifies said geometrical parameter of the internal display as a function of said item of adjustment data.

16/ A method according to claim 15, in which the interface comprises a reader interface for reading data media, and said item of adjustment data is loaded by causing a data medium to be read by said interface.

17/ A method according to claim 15, in which the interface comprises a telecommunications interface, and said item of adjustment data is downloaded via said telecommunications interface.

18/ A method according to claim 17, in which data is read from the poster, and the item of adjustment data corresponding to the data read from the poster is downloaded.

19/ A method according to claim 17, in which the image-presenting device is an electronic screen, and at least one internal display program is downloaded that is to be displayed on the screen as a function of the data read from the poster.

20/ A method according to claim 12, in which the image-presenting device is an electronic screen, data is read from the poster, and, as a function of said data, an internal display program that corresponds to the poster and that is selected from a plurality of internal display programs is presented on the screen.
